(19) United States
(12) Patent Application Publication
(10) Pub. No.: US 2024/0166051 A1
(43) Pub. Date: May 23, 2024

(54) CONTROL DEVICE FOR ELECTRIFIED VEHICLE

(71) Applicant: TOYOTA JIDOSHA KABUSHIKI KAISHA, Toyota-shi (JP)

(72) Inventor: Yusuke FURUHASHI, Nagoya-shi (JP)

(73) Assignee: TOYOTA JIDOSHA KABUSHIKI KAISHA, Toyota-shi (JP)

(21) Appl. No.: 18/471,633

(22) Filed: Sep. 21, 2023

(30) Foreign Application Priority Data
Nov. 21, 2022 (JP) 2022-185674

(51) Int. Cl. B60L 1/00

(52) U.S. Cl. CPC B60L 1/006; B60L 2210/40; B60L 2260/20

(57) ABSTRACT

A control device of an electrified vehicle configured to be capable of supplying power to an external device from a power supply for supplying power to a motor via an outlet provided in a vehicle cabin, the control device comprising: an inverter for changing output power of the power supply and outputting the output power to the outlet; and a controller for controlling the inverter, wherein the controller sets an upper limit value of power to be output from the inverter to the outlet in a case where the first travel mode for reducing power consumption by the motor from the normal mode is set to a first predetermined upper limit value lower than in a case where the normal mode is set, and stops the inverter in a case where the second travel mode for reducing power consumption by the motor from the first travel mode is set.

### CROSS-REFERENCE TO RELATED APPLICATION

This application claims priority to Japanese Patent Application No. 2022-185674 filed on Nov. 21, 2022 incorporated herein by reference in its entirety.

### BACKGROUND

### 1. Technical Field

The present disclosure relates to a control device for an electrified vehicle that travels by energizing a motor from a power source.

### 2. Description of Related Art

Japanese Unexamined Patent Application Publication No. 2019-127096 (JP 2019-127096 A) describes a control device for a vehicle that can perform autonomous driving. The control device is configured to reduce energy consumption of an air conditioner when an eco-mode is set and the air conditioner is automatically operated. Specifically, the control device is configured such that blowing of the air-conditioning air from an air outlet provided in an instrument panel is stopped, and the air-conditioning air is blown out only from the air outlet provided in a roof inner surface between a driver's seat and a rear seat, in a state in which the backrest of the driver's seat is tilted. The control device is configured such that the air-conditioning air is blown out from the air outlet between the instrument panel and the roof inner surface in order to satisfy the driver's request, when the air conditioner is set to the maximum output.

Japanese Unexamined Patent Application Publication No. 2016-82678 (JP 2016-82678 A) describes a control device for a vehicle including a fuel cell. In this vehicle, a fuel cell-side power line connected to the fuel cell and an inverter-side power line connected to an inverter that controls power of the motor are connected via a fuel cell (FC) boost converter, and a battery-side power line connected to a battery is connected to a connecting portion between the FC boost converter and the inverter-side power line, and an outlet for supplying power to an external device is connected to the battery-side power line. When an eco-mode is set, the voltage of a capacitor in the boost converter provided between the battery-side power line and the inverter-side power line is increased as compared with a case where a normal mode or a power mode is set, so that the voltage difference with the voltage of the capacitor in the FC boost converter is reduced, and the power supplied to the external device is reduced. The power is supplied to the external device when the vehicle is stopped.

Japanese Unexamined Patent Application Publication No. 2022-50026 (JP 2022-50026 A) describes a vehicle capable of supplying power from a battery to an outlet provided in the vehicle via an alternating current (AC) 100 V inverter. This vehicle is a vehicle used in a mobile shop or the like, and is configured so as not to cause troublesomeness to operate an AC 100 V switch that permits use of an in-vehicle outlet every time a vehicle system is activated. Specifically, the vehicle is configured to store, in an electronic control unit (ECU), a first mode in which the in-vehicle outlet can be used after the vehicle system is activated and a second mode in which the in-vehicle outlet cannot be used after the vehicle system is activated. The vehicle is configured to be able to use the AC 100 V outlet by operating the AC 100 V switch, when the second mode is set.

### SUMMARY

The control device described in JP 2019-127096 A and JP 2016-82678 A is configured to reduce the amount of power used by the battery, by reducing the total output of the air conditioner or reducing the output power to the external device in a case where the eco-mode is set as compared with a case where the so-called normal mode is set. However, an electrified vehicle is required to have a long cruising distance because the distance at which power can be supplied to a power storage device is long and the time required for power supply is long. That is, it is required to further reduce the power consumption.

The present disclosure has been made by focusing on the above-described technical issues, and an object of the present disclosure is to provide a control device for an electrified vehicle capable of increasing the cruising distance.

In order to achieve the above object, a control device for an electrified vehicle configured to be able to supply power from a power source for supplying power to a motor as a driving force source to an external device via an outlet provided in a vehicle cabin, in which:
the electrified vehicle is configured to be able to set at least three travel modes of a normal mode, a first travel mode for reducing power consumption by the motor as compared with the normal mode, and a second travel mode for reducing the power consumption by the motor as compared with the first travel mode, and
the electrified vehicle includes an inverter for changing output power of the power source and outputting the changed output power to the outlet, and a controller for controlling the inverter; and
the controller
sets an upper limit value of the power to be output from the inverter to the outlet when the first travel mode is set to a first predetermined upper limit value that is lower than a case in which the normal mode is set, and stops the inverter when the second travel mode is set.

In the present disclosure, the control device may include an operation unit for permitting the power of the power source to be supplied to the external device via the outlet in response to an operation of an occupant of the electrified vehicle; and
the controller
may start the inverter when the second travel mode is set and the operation unit is operated, and set the upper limit value of the power to a second predetermined upper limit value that is lower than a case in which the normal mode is set.

In the present disclosure, the first predetermined upper limit value and the second predetermined upper limit value may be the same power.

In the present disclosure, the first travel mode may include an eco-mode in which a driving gain that is torque of the motor with respect to a driving operation amount by a driver or a change amount of the torque of the motor with respect to a change amount of the driving operation amount is set to be the same as in the normal mode; and
the second travel mode may include a range mode in which the driving gain is smaller than in the eco-mode.

In the present disclosure, in the eco-mode, a response that is a time to change to a driving force corresponding to the driving operation amount may be slower than in the normal mode; and
in the range mode, the response may be the same as in the eco-mode.

According to the present disclosure, in a case where the first travel mode in which the power consumption by the motor is reduced as compared with the normal mode is set, the power to be output from the inverter to the outlet is limited to the first predetermined power, and thus the power consumption of the power source can be suppressed as compared with the normal mode. In addition, in a case where the second travel mode in which the power consumption by the motor is reduced as compared with the first travel mode is set, the inverter is stopped. That is, the power supply to the external device via the outlet is stopped. Therefore, the power consumption by the external device can be suppressed, and the power consumption such as electric resistance caused by driving the inverter can be suppressed. As a result, it is possible to increase the cruising distance at the time of setting the second travel mode, that is, to perform traveling suitable for the set travel mode.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an equivalent circuit diagram for explaining an exemplary electric circuit provided in an electrified vehicle according to an embodiment of the present disclosure;

FIG. 2 is a diagram for explaining an example of a traveling characteristic according to a traveling mode to be set;

FIG. 3 is a diagram for explaining a relationship between a driving performance, a comfort performance, and a cruising distance according to a driving mode to be set;

FIG. 4 is a diagram for explaining a relation between an accelerator operation amount and an acceleration of a vehicle when a range mode is set; and

FIG. 5 is a flowchart for explaining a control example executed by the control device according to the embodiment of the present disclosure.

### DETAILED DESCRIPTION OF EMBODIMENTS

The present disclosure will be described with reference to the embodiments shown in the drawings. Note that the embodiments described below are merely examples of a case where the present disclosure is embodied, and are not intended to limit the present disclosure.

An electrified vehicle according to an embodiment of the present disclosure is a vehicle that travels by supplying electric power to a motor serving as a driving force source. Electrified vehicle can be applied to various vehicles such as a battery electric vehicle that runs by supplying electric power from a power storage device to a motor, a fuel cell electric vehicle that runs by supplying electric power generated by a chemical reaction between hydrogen and air to the motor, and a hybrid electric vehicle including an engine as a driving force source in addition to the motor.

Hybrid electric vehicle may be a series-type hybrid electric vehicle capable of converting the power of the motor into electric power and supplying the converted electric power to the motor to travel. Alternatively, hybrid electric vehicle may be a parallel-type hybrid electric vehicle capable of transmitting the power of the motor to the drive wheels and transmitting the power of the motor to the drive wheels to travel. Alternatively, hybrid electric vehicle may be a series-parallel hybrid electric vehicle capable of transmitting a portion of the power of the engine to the drive wheels, converting the remaining power into electric power, supplying the electric power to the motor, and transmitting the power of the motor to the drive wheels to travel.

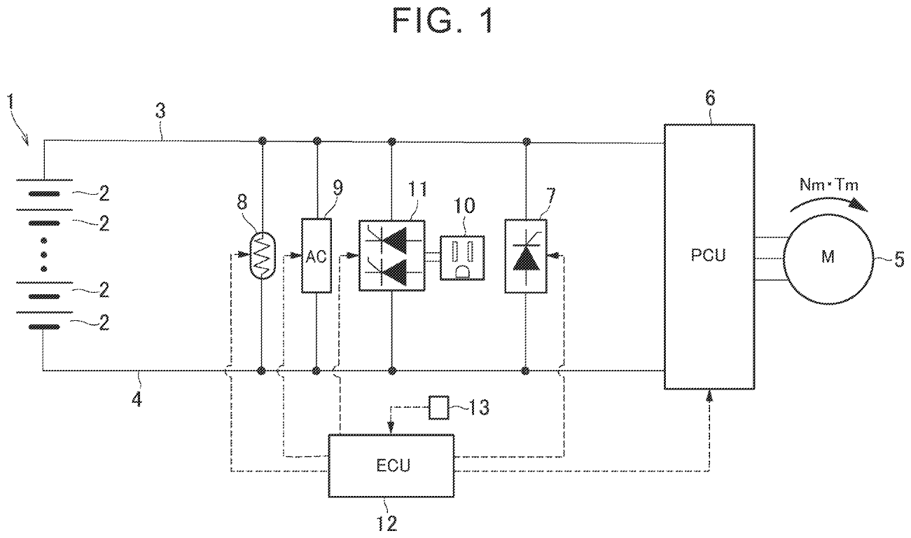

FIG. 1 is an equivalent circuit diagram for explaining an exemplary electric circuit provided in a electrified vehicle where electric power is supplied from a power storage device serving as a power source to a motor and travels. The electric circuit shown in FIG. 1 comprises a battery 1. The battery 1 can be configured in the same manner as a traveling battery provided in a conventional electrified vehicle. That is, the battery 1 is configured by connecting a plurality of battery cells 2 constituted by a secondary battery such as a lithium ion battery in series. Note that the battery 1 may be configured to be able to be charged by electric power of an external power source (not shown).

A motor (M) 5 is connected to the positive line 3 and the negative line 4 of the battery 1. The motor 5 can be configured in the same manner as a conventional electrified vehicle. That is, the motor 5 can be configured by a motor generator having a function as a generator that generates electric power by being supplied with electric power and by being rotated by the motor 5 in addition to a function as a motor that generates driving torque. Specifically, the motor 5 can be constituted by a permanent magnet synchronous motor including a permanent magnet in a rotor, an induction motor, or the like.

A power control unit (hereinafter referred to as a PCU) 6 for controlling electric power to be supplied to the motor 5 is provided between the battery 1 and the motor 5. PCU6 includes inverters formed by combining a plurality of non-illustrated insulated-gate bipolar transistors, diodes, and the like. PCU6 is configured to convert a DC voltage outputted from the battery 1 into an AC voltage and apply the AC voltage to the motor 5. The electric power generated by the motor 5 is converted into DC electric power by PCU6 and charged into the battery 1.

A DCDC converter 7 is provided between the battery 1 and PCU6. DCDC converter 7 is configured to control a voltage applied to PCU6 and to convert a voltage generated by the motor 5 into a voltage for charging the battery 1, and can be configured similarly to a DCDC converter provided in a conventional electrified vehicle.

In addition to supplying electric power to the motor 5 as electric power for driving, the battery 1 is configured to be capable of supplying electric power to various devices provided in electrified vehicle. In the example shown in FIG. 1, power is supplied to the air conditioner. Specifically, power is supplied to the water heater 8 for functioning as heating and the compressor (AC) 9 functioning as cooling. In the example shown in FIG. 1, the water heater 8 and the compressor 9 are connected in parallel.

Further, in electrified vehicle according to the embodiment of the present disclosure, an outlet 10 for connecting the battery 1 and an external device is provided in the vehicle cabin, and power is supplied to the external device connected to the outlet 10 by supplying power from the battery 1 to the outlet 10. Specifically, between the battery 1 and the outlet 10, an AC 100V inverter 11 for converting a DC voltage (DC power) output from the battery 1 into an AC voltage (AC power) of 50 Hz or 60 Hz and converting the output voltage (output power) into a voltage (power) of 100V is provided. AC100V inverter 11 can be configured in the same manner as AC 100V inverter provided between the outlet 10 and the battery 1 of the conventional electrified vehicle.

An electronic control unit (hereinafter referred to as an ECU) 12 for controlling PCU6, DCDC converter 7, AC 100V inverter 11, the compressor 9, and the water heater 8 is provided. This ECU 12 corresponds to a “controller” in an embodiment of the present disclosure, and is mainly composed of a microcomputer, similar to an ECU provided in a conventional vehicle. That is, ECU 12 is configured to receive signals from various sensors provided in electrified vehicle, and to provide signals for controlling PCU6, DCDC converters 7, AC100V inverters 11, the compressors 9, and the water heaters 8 based on the input signals and a map, an arithmetic expression, or the like stored in advance.

ECU 12 receives a signal from, for example, a switch for switching on/off of the air conditioner, a switch for setting the temperature thereof, a switch for permitting use of the outlet 10, an accelerator operation amount sensor for detecting an operation amount of the accelerator pedal, a brake sensor for detecting an operation of the brake pedal, a vehicle speed sensor for detecting a vehicle speed, a switch for selecting a traveling mode to be described later, and the like. In FIG. 1, for convenience, these switches and sensors are collectively shown as a single sensor 13.

Further, electrified vehicle according to the embodiment of the present disclosure is configured such that a predetermined traveling mode can be selected from a plurality of traveling modes by a driver's switching operation. Specifically, electrified vehicle is configured to be able to select a driving mode required by the driver from a sporting mode (power mode), a normal mode, an eco-mode, and a range mode. In each of these modes, a response, which is a time until an actual driving force or braking force is changed toward a driving force or a braking force corresponding to an operation amount of an accelerator pedal (hereinafter, referred to as an accelerator operation amount) or an operation amount of a brake pedal (hereinafter, referred to as a brake operation amount) by a driver, is set differently. In addition, when the accelerator operation amount, the brake operation amount, and the like used during steady travel are in a predetermined operation amount or a predetermined operation amount or less, the magnitude of the torque of the motor 5 with respect to the accelerator opening degree and the brake operation amount, and the magnitude of the change amount of the torque of the motor 5 with respect to the accelerator operation amount and the change amount of the brake operation amount (hereinafter, these are collectively referred to as Gain) are set differently. In the following description, the accelerator operation amount and the brake operation amount are collectively referred to as a driving operation amount, and are referred to as a driving force including a braking force.

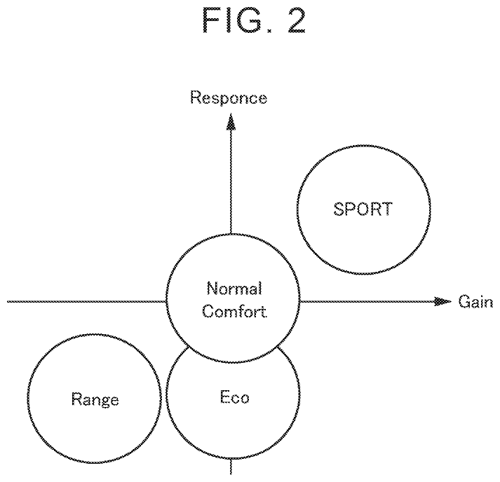

FIG. 2 shows the relation between the response and Gain. In the sport mode, it is required to quickly generate a driving force corresponding to the driving operation amount. Therefore, as shown in FIG. 2, the sport mode is set so that the response is best. In addition, in the sport mode, it is required to generate a large driving force in a region where the driving operation amount is small, and to realize a large change in the driving force by slightly changing the driving operation amount. Therefore, as shown in FIG. 2, Gain of the sporting mode is set to be the largest. This Gain corresponds to the “driving gain” in the embodiment of the present disclosure.

The normal mode is a mode serving as a reference for a response or a Gain, and is set to a response or a Gain equivalent to a response or a Gain used in conventional vehicles. Therefore, as shown in FIG. 2, the response is set to be slower than in the sporting mode, and Gain is set to be smaller.

In the eco mode, the driving force is required to change more slowly than in the normal mode, and therefore, as shown in FIG. 2, the response is set slowly in the eco mode. On the other hand, in the embodiment shown here, Gain in the eco-mode is set to be equal to the normal mode. When the amount of change in the driving force is large, the power consumption efficiency is deteriorated, and therefore it may be preferable to reduce the amount of change in the driving force with respect to the amount of change in the driving operation amount. Therefore, Gain in the eco-mode may be set to be smaller than that in the normal mode.

Since the range mode is required to have a long cruising distance within a possible range, it is required to travel in an operating state in which the energy efficiency is better than that of the eco mode. Therefore, in the embodiment shown in FIG. 2, the response in the range mode is set to be equal to that in the eco mode, but Gain of the range mode is set to be smaller than that in the eco mode. In the range mode, the response may be set to be smaller than that in the eco mode. That is, the range mode is configured to control the driving force such that the energy-efficiency during traveling becomes better than that in the eco-mode by setting at least one of the response and Gain to be smaller than that in the eco-mode.

The maximum driving force in the sport mode, the normal mode, and the eco mode is set to be the same. Further, the maximum driving force in the range mode is limited to a driving force smaller than that in the sport mode, the normal mode, and the eco mode.

As described above, the response changes according to the travel mode to be set. This response is the time from the driver's driving operation until the driving force changes to the target driving force, in other words, the rate of change of the driving force toward the target driving force. Therefore, as the response increases, the operating point of the motor 5 changes while the operating point of which the energy efficiency is not good is changed, and the energy efficiency of the motor 5 is deteriorated. That is, the eco mode is a traveling mode in which power consumption by the motor 5 is reduced more than in the normal mode, and corresponds to the “first traveling mode” in the embodiment of the present disclosure.

Gain changes according to the driving mode set as described above. This Gain is the magnitude of the required driving torque and the required braking torque of the motor 5 with respect to the driving operation amount in the area where the driving operation amount is small, and the magnitude of the change amount of the torque of the motor 5 with respect to the change amount of the driving operation amount. Therefore, the smaller Gain is, the smaller the driving force in the normal use range is set, and even when the driving operation is slightly changed, the amount of change in the driving force can be reduced, so that the energy consumed by the motor 5 can be reduced. That is, the range mode is a running mode in which the power consumption by the motor 5 is reduced more than in the eco mode, and corresponds to the “second travel mode” in the embodiment of the present disclosure.

That is, the range mode is a driving mode in which the energy consumption (power consumption) is the smallest, and the energy consumption increases in the order of the eco mode, the normal mode, and the sport mode. This is because the range mode is a traveling mode that is intended to increase the cruising distance more than the traveling performance or the like. In the range mode, in addition to setting the response and Gain to be small, the deceleration during inertia is set to be small compared with the normal mode and the eco mode, thereby reducing the chance of accelerating and decelerating the vehicle. Further, in the range mode, the maximum output and the maximum vehicle speed are set to be smaller than those in the normal mode or the eco mode, so that the power consumption is reduced.

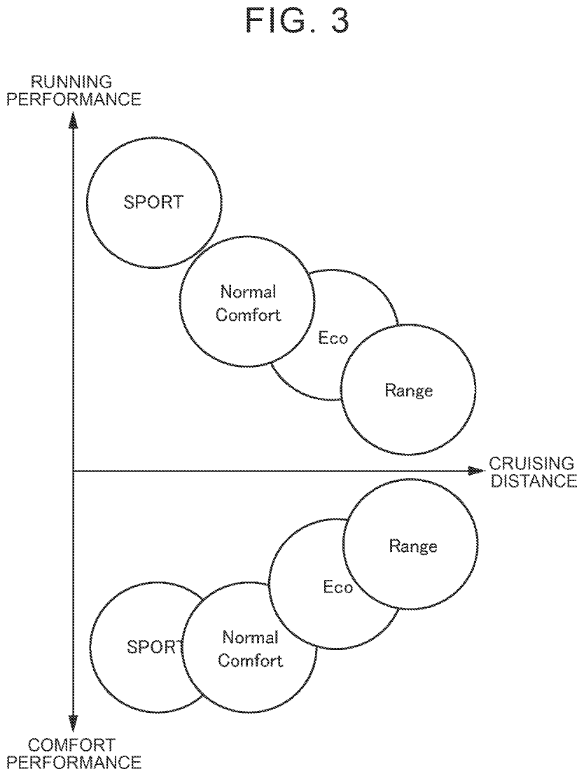

FIG. 3 is a diagram in which the traveling performance in each traveling mode, the comfort performance in the vehicle cabin, and the degree of the target size of the cruising distance are distributed. As shown in FIG. 3, in the sport mode, while the traveling performance and the comfort performance are the best, power is consumed in order to improve the traveling performance and the comfort performance, and thus the cruising distance is shortened. The driving performance and the comfort performance decrease in the order of the normal mode, the eco mode, and the range mode, while the cruising distance increases in the order described above.

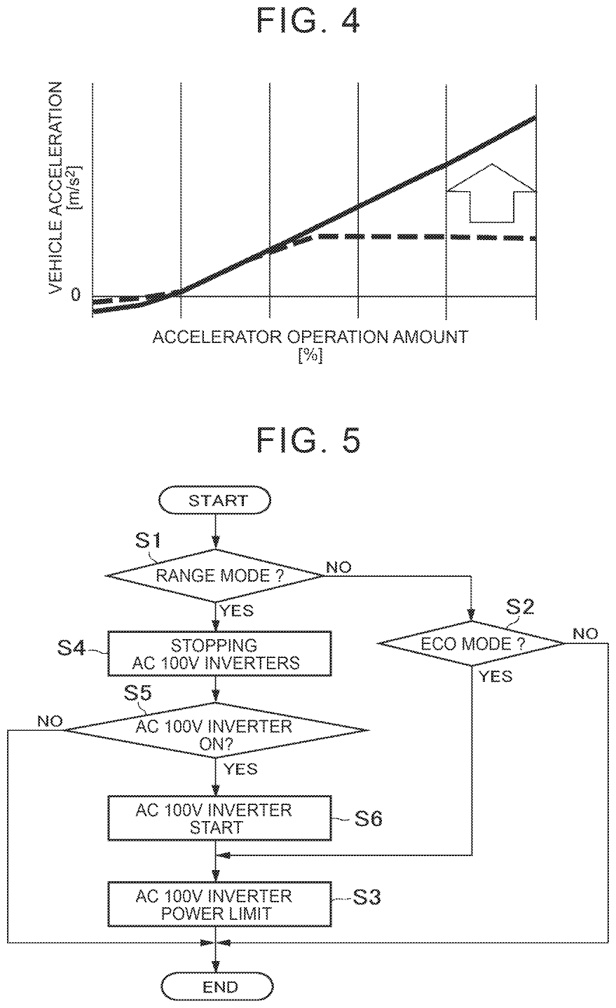

In the range mode as described above, the maximum drive torque and the maximum braking torque of the motor 5 are limited. Therefore, when an accelerator override operation is performed as indicated by a solid line in FIG. 4, torque is output up to a torque (i.e., acceleration) exceeding a limit torque (i.e., a limit acceleration) indicated by a broken line in FIG. 4 in order to reflect the driver's intention to perform a driving operation. Here, the accelerator override is a driving operation in which it is determined that the driver's driving operation is required to increase the driving force by deviating from the characteristic of the driving force set in the range mode. For example, the accelerator override is a driving operation in a case where the driving operation amount is equal to or more than a predetermined amount and the change rate (change speed) of the driving operation amount is equal to or more than a predetermined rate.

As described above, the range mode is configured to increase the cruising distance even if the driving performance and the comfort performance are deteriorated. Therefore, the control device according to the embodiment of the present disclosure is configured to prohibit the use of the outlet 10 in order to reduce the power consumption of the battery 1 when the range mode is set. In other words, when the range mode is set, AC 100V inverters 11 are stopped. FIG. 5 is a flowchart for explaining an example of the control.

In the embodiment illustrated in FIG. 5, first, it is determined whether or not the mode is the range mode (S1). S1 may be determined based on ECU 12 input from the driving mode-selection switch.

When a negative determination is made in S1 due to the fact that the mode is not the range mode, it is determined whether the mode is the eco-mode (S2). In this S2 as well, it is possible to make a determination on the basis of a signal inputted to ECU 12 from a switch for selecting the traveling mode as in the case of S1.

When the normal mode or the sporting mode is selected and S2 determines that the mode is not the ecological mode, the routine is terminated once. That is, the use of the outlet 10 is permitted. In other words, AC 100V inverters 11 are appropriately controlled. On the contrary, if S2 is determined to be positive due to the eco-mode, the output power of AC 100V inverters is limited to a predetermined upper limit or less (S3), and this routine is terminated once. That is, although the use of the outlet 10 is permitted, the usable power is lowered as compared with a case where the normal mode or the sport mode is selected.

On the other hand, if S1 is determined to be positive due to the range mode, AC 100V inverters 11 are stopped (S4). That is, use of the outlet 10 is prohibited. Then, it is determined whether or not driving of AC 100V inverters 11 is required (ON) (S5). S5 can be determined based on a signal inputted to ECU 12 from a switch permitting use of the outlet 10 provided in the vehicle cabin. The switch permitting use of the outlet 10 is operated by an occupant, and corresponds to an “operation unit” in the embodiment of the present disclosure.

If it is determined negatively in S5 that the driving of AC 100V inverters 11 is not required, the routine is terminated once. That is, AC 100V inverters 11 are kept stopped. On the contrary, when AC 100V inverter 11 is requested to be driven and thus is determined to be positive in S5, S6 of AC 100V inverter 11 proceeds to S3. That is, in the case where the range mode is set, even if it is requested to use the outlet 10, the power is limited to the upper limit power equivalent to that in the case where the eco mode is set. That is, the upper limit value of the output power of AC 100V inverters 11 is set to a smaller value than when the normal mode is set. Note that the upper limit power in the case where the range mode is set may be set to a smaller value than the upper limit power in the case where the eco mode is set, the upper limit power in the case where the eco mode is set corresponds to the “first predetermined upper limit value” in the embodiment of the present disclosure, and the upper limit power in the case where the range mode is set and AC 100V inverter 11 is driven corresponds to the “second predetermined upper limit value” in the embodiment of the present disclosure.

When the range mode is set as described above, by stopping AC 100V inverter 11, power consumption by an external device connected to the outlet 10 can be suppressed, and by driving AC 100V inverter 11, power consumption such as an electric resistor can be suppressed. As a result, it is possible to increase the cruising distance at the time of setting the range mode, that is, to perform the traveling suitable for the set traveling mode (range mode).

When the use of the outlet 10 is requested while the range mode is set, AC 100V inverters 11 are activated to reflect the request of the occupant. Further, even if AC 100V inverters 11 are activated as described above, the power used is limited to the same level as when the eco-mode is set, so that the power of the battery 1 can be suppressed from being excessively lowered, and a decrease in the cruising range can be suppressed.

What is claimed is:

1. A control device for an electrified vehicle configured to be able to supply power from a power source for supplying power to a motor as a driving force source to an external device via an outlet provided in a vehicle cabin, wherein:
the electrified vehicle is configured to be able to set at least three travel modes of a normal mode, a first travel mode for reducing power consumption by the motor as compared with the normal mode, and a second travel mode for reducing the power consumption by the motor as compared with the first travel mode, and
the electrified vehicle includes an inverter for changing output power of the power source and outputting the changed output power to the outlet, and a controller for controlling the inverter; and
the controller
sets an upper limit value of the power to be output from the inverter to the outlet when the first travel mode is set to a first predetermined upper limit value that is lower than a case in which the normal mode is set, and
stops the inverter when the second travel mode is set.

2. The control device according to claim 1, wherein:
the control device includes an operation unit for permitting the power of the power source to be supplied to the external device via the outlet in response to an operation of an occupant of the electrified vehicle; and
the controller starts the inverter when the second travel mode is set and the operation unit is operated, and sets the upper limit value of the power to a second predetermined upper limit value that is lower than a case in which the normal mode is set.

3. The control device according to claim 2, wherein the first predetermined upper limit value and the second predetermined upper limit value are the same power.

4. The control device according to claim 1, wherein:
the first travel mode includes an eco-mode in which a driving gain that is torque of the motor with respect to a driving operation amount by a driver or a change amount of the torque of the motor with respect to a change amount of the driving operation amount is set to be the same as in the normal mode; and
the second travel mode includes a range mode in which the driving gain is smaller than in the eco-mode.

5. The control device according to claim 4, wherein:
in the eco-mode, a response that is a time to change to a driving force corresponding to the driving operation amount is slower than in the normal mode; and
in the range mode, the response is the same as in the eco-mode.
